(19) United States
(12) Patent Application Publication
(10) Pub. No.: US 2025/0115742 A1
(43) Pub. Date: Apr. 10, 2025

(54) LEATHER-LIKE MATERIAL FROM PLANT-BASED WASTES, PROCESS OF MANUFACTURING AND USE OF SAID LEATHER-LIKE MATERIAL

(71) Applicants: PLHYDE, INC., Marina Del Rey, CA (US); UNIVERSITÀ DEGLI STUDI DI MILANO-BICOCCA, Milano (IT)

(72) Inventors: Rebecca MINK, Marina Del Rey, CA (US); Roberto SIMONUTTI, Milano (IT); Michele MAURI, Milano (IT)

(73) Assignees: PLHYDE, INC., Marina Del Rey, CA (US); UNIVERSITÀ DEGLI STUDI DI MILANO-BICOCCA, Milano (IT)

(21) Appl. No.: 18/727,245

(22) PCT Filed: Apr. 15, 2022
(86) PCT No.: PCT/US2022/025118

§ 371 Date: Jul. 8, 2024

(30) Foreign Application Priority Data
Jan. 12, 2022 (IT) 202022000000089

(51) Int. Cl. C08L 1/02; B09B 3/35; B09B 101/70

(52) U.S. Cl. CPC C08L 1/02; B09B 3/35; B09B 2101/70; C08L 2201/06; C08L 2205/035; C08L 2312/00

(57) ABSTRACT

A process is disclosed for making a printed plant-based leather, a printed plant-based leather obtainable by the process, and the use of the plant-based leather, such as in outer garments, including shoes, boots, jackets, belts, accessories, such as bags and wallets, and seat covers, such as for automotive and furniture applications. The process and the composition involve plant-based wastes of one or more sources and wherein each waste contains at least one of the following biopolymers: cellulose, hemicellulose, pectin, lignin, aliphatic polyesters, and starch.

### FIELD OF ART

The present invention relates to a process for making or preparing a printed plant-based leather, a printed planted-based leather obtainable by said process, and the use of said plant-based leather, such as outer garments, including shoes, boots, jackets, belts, accessories, such as bags and wallets, and seat covers, such as for automotive and furniture applications, among others. As used herein, plant-based materials and leather derived from said plant-based materials include vegetables, fruits, and plants.

### BACKGROUND

US2009303147A1 discloses an apple textile composition made of apple flour and 5% polymer binder. The manufacturing technique for obtaining the apple textile can be used only for dry powders and requires a high-pressure forming process.

US2013149512A1 discloses a natural non-woven material made from multi-layer stack of discrete interconnected plant fiber layers bound by a biodegradable polymer. This application relates to the use of plant-based fibers, in particular pineapple fibers, to manufacture a fused non-woven material.

WO2015018711A11 discloses a method for making spinnable cellulose from citrus fruits discarded by citrus fruit plantations or wasted during processing of citrus fruit derivatives. The method includes chemical treatment used to extract cellulose from the citrus fruits. The method is limited to citrus fruits and involves polysaccharide separation processes.

US20090169694A1 and KR100275214B1 disclose a method for the fabrication of edible rolled sheets of fruit material from fruit mass.

The company “Fruitleather Rotterdam” produces leather-like material starting from fruit wastes, typically mangos, but the method is not known to be publicly disclosed.

WO2021/121509A2 discloses a hydrophobic non-woven textile and a method of production starting from fruit or vegetable pomace, mixing the disrupted pomace with a density-modifying agent, dehydrating the pomace and distributing it on surface. A final step of drying and coating with a hydrophobic polymer leads to the non-woven textile. Further, only apple pomace is used.

A completely different approach is disclosed in U.S. Pat. No. 8,202,379 B1, which describes a method for joining fibrous material comprising partially dissolving either fibrous biopolymer or fibrous synthetic polymer materials with a mixture of ionic liquids and organic solvents. This process is termed “natural welding” since the fibrous biopolymers are transformed to create a congealed network. In US2017165891A1 a method, based on natural welding, is disclosed for increasing the mechanical properties of cellulose, hemicellulose and silk.

### SUMMARY

The term “plants” refers to a group of living organisms that have cellulose in their cell walls, possess chlorophylls a and b, and have plastids, organelle bound to membranes, which are capable of photosynthesis and of storing starch. Most of the solid material in a plant is taken from the atmosphere. Through the process of photosynthesis, most plants use the energy in sunlight to convert carbon dioxide from the atmosphere, plus water, into simple sugars. These sugars are then used as building blocks that form the main structural components of the plant. Among these, six biopolymers represent the large majority of the plant mass, which are:
1. Cellulose
2. Hemicellulose
3. Pectin
4. Lignin
5. Aliphatic Polyesters
6. Starch

Through different weight balance among these components, together with a controlled organization at the nanometric as well micrometric level, plants can exhibit different mechanical and physical-chemical properties. For example, an overabundance of cellulose and lignin in hardwoods can lead to tough materials with high strength and stiffness, whereas large presence of starch can reduce mechanical properties in seeds like yam, cassava and corn.

Fruits, which are plant-based, like pears, apples, guavas, quince, plums, gooseberries, and oranges and other citrus fruits contain large amounts of pectin. Pectin is a complex polysaccharide consisting mainly of esterified d-galacturonic acid residues linked by α-(1-4) chain. The acid groups along the chain are largely esterified with methoxy groups in the natural product. Pectins thus are able to form stable gels.

Hemicellulose is the second class of polysaccharides that exist in plant cell walls, comprising approximately 25% of most plant walls, with the amount varying based on the particular plant. Hemicelluloses are the amorphous cell wall constituents, which fill the space between the fibrils in both primary and secondary walls. Hemicelluloses have the capability to link noncovalently throughout hydrogen bonding to cellulose and to connect covalently to lignin.

Considering the very different properties that plants exhibit, and that at the core of these there are typically the six biopolymers described above (called the “big six”), an incredible variety of materials can foreseeably be created by balancing makeups of the big six.

A possible approach to the fabrication of new materials can be the use of one or more biopolymers of the big six, after careful selection and purification. This approach has occurred in many fields, for example in the production of paper and paperboard or in Mater-Bi that exploits gelatinized starch. This approach can be very fruitful in the control of the final properties of the material, but it requires a long and complex process of purification that generally consumes a lot of energy and generate large amounts of waste.

The United Nations Food and Agriculture Organization (FAO) has estimated that losses and waste in fruits and vegetables are the highest among all types of foods and may reach up to 60% of the raw production. The processing operations of fruits and vegetables produce significant wastes of by-products, which constitute about 25% to 30% of a whole commodity group. The waste is composed mainly of seed, skin, rind, and pomace, which contain good and large sources of the big six. Most of this waste is inherently not edible, and thus will not be reduced by programs aimed at increasing the efficiency of the food sector. Furthermore, the supramolecular organization of the components, which can vary by plants, confers to the different types of waste different properties, such as mechanical, rheological or physico-chemical. As examples, seeds are typically hard and tough while the intern of the cladodes of the Opuntia cactus are largely constituted by a jellified mixture of carbohydrate polymers. In addition, the peel of many fruits can vary in flexibility and resistance due to variations in the big six.

Not considering the presence of small quantities of other components (e.g., oils, fragrances, proteins, etc.) that can be important in specific cases, such as cocoa husks, the final properties of the specific part of the plant, and therefore of the waste, can be determined by the precise balance among the big six.

Main characteristics of the biopolymers of the big six:

### Cellulose

Cellulose is the main component of cell walls of plants, representing about 20-40% of all the polysaccharides. It is a polymer of glucose units linked by β-1,4-glucosidic bonds, with an average degree of polymerization of 10000-15000 monomer units. Cellulose chains pack tightly together and crystalline structures can constitute up to 90% of cellulose, depending on the source, giving rise to a linear structure and ability to form strong intermolecular hydrogen bonds. Different crystals are then assembled tidily together to generate cellulose microfibrils. Its crystallinity confers it with mechanical robustness, water insolubility, thermal resistance, limited oxygen permeability, whereas its chemical composition makes it hydrophilic. The cellulose content of cotton fiber is about 90%, that of wood is about 40-50%, and that of dried hemp is approximately 57%.

### Hemicellulose

Hemicellulose is the second most abundant polysaccharide, with percentages between about 15-35% of biomasses, present along with cellulose in almost all terrestrial plant cell walls. While cellulose is crystalline, strong, and resistant to hydrolysis, hemicelluloses have random, amorphous structure with little strength. It is composed by several different types of monosaccharides units that can include the five-carbon sugars xylose and arabinose, the six-carbon sugars glucose, mannose and galactose, and the six-carbon deoxy sugar rhamnose. Its structure is not linear but branched, which is essentially absence of crystallinity, and its molecular weights are lower than cellulose. The role of hemicellulose is to connect the cellulose microfibrils and prevent their aggregation.

### Pectin

Pectin is constituted primarily by galacturonan repeating units linked by α-1,4 glycosidic bonds. As for hemicellulose, different types of pectins can be differentiated depending on the substituting or branching units and on the degree of methylesterification. Four regions can be identified: homogalacturonan, xylogalacturonan and two types of rhamnogalacturonan. The latter three types are branched systems; the former is constituted by a mixture of galacturonic acid and its methylesterified form. Usually, pectins in vegetables are heavily substituted with methoxyl groups and their demethylation is promoted by environmental conditions or extraction procedures.

Pectins are mainly amorphous, water-soluble and water absorbent, and are able to form a hydrogel structure. Gel formation conditions depend on methylation degree: in low methoxyl (LM) pectins (<50%), gelation is promoted by the presence of positive cations in solution, such as calcium or iron, which are chelated by the carboxyl groups, creating metal complexes acting as crosslinks point. In high methoxyl (HM) pectins, gelation typically occurs in acidic media and in presence of a co-solute, following hydrolyzation of the methoxyl group and formation of complexes.

### Lignin

Lignin is not part of polysaccharides family but it is a phenolic polymer, often with high degree of crosslinking. Although its composition is complex, it is widely recognized that it results from the polymerization of three main phenylpropane units: coniferyl (guaiacyl), synapil (syringil) and p-coumaryl alcohols. Their chemical structure varies only in terms of substituting groups on the aromatic ring. Guaiacyl (G) is monosubstituted with a methoxyl moiety, syringil (S) is di-substituted and p-hydroxyphenyl (p-coumaryl) (H) has no substituting groups. Commonly the polymerization happens with β-O-4 linkages on one hand, and on the other by alkyl or ether bonds. The great versatility in chemical reactivity of monolignols in terms both of reaction sites and linkage types creates a three dimensional network that binds together cellulose fibrils and hemicellulose, imparting the whole cell wall with mechanical strength, thanks to the rigidity of aromatic groups. It is hydrophobic with a tendency to self-aggregate in water, aided by Van der Waals and π stacking. Different natural sources originate lignins with different concentrations of each unit, changing slightly their chemical properties and structural organization, such as crosslinking or branching degree. In particular, herbaceous crops possess a higher concentration of H, which is usually totally absent in wood sources.

### Aliphatic Polyesters

Cutin and Suberin are biopolyesters allocated in the cuticle of the plant. They composed mainly of saturated and unsaturated @-diacids and hydroxyacids and their derivatives can be modified with epoxy or diols, alkenediols, fatty acids and in minor quantity with glycerol and ferulic acid. Typical length of the carbon chains of these monomers are C₁₆ and C₁₈ for cutin, and C₁₆ up to C₂₈ for suberin. They are linked through ester bonds, forming a complex crosslinked network, where diacids and diols can act as crosslinking units, The mono-functional monomers can be chain terminals or extend the chains and derivatized units can produce branching. This arrangement is essentially amorphous and give rise to a hydrophobic layer in the plant, which acts as a protective barrier against water loss and pathogens, regulates molecular diffusion among organs and has also unclear biomechanical roles, providing some levels of viscoelasticity to the cell walls.

### Starch

Unlike previous polysaccharides, starch does not have a structural role in plants, but acts as an energy storage. Its composition is similar to cellulose, with repeating units of glucose, but its structure is heterogeneous since there are two different molecule types: amylose and amylopectin. Amylose possess a linear, helical structure, with low molecular weight, which makes it crystalline, whereas amylopectin is branched and amorphous. It is water-soluble and water-absorbent, forming a gel at high temperature in solution, because of the complete amylose dissolution in water and the formation of a network due to percolating chains plasticized by water.

The mechanical and physical properties displayed by each plant or part thereof depend mainly on the composition, and secondarily to the morphology that the plant imparts to them by organizing them in phases and structures at different scales. Thus, it is possible to preserve the useful properties of the parent plant, such as the seed, peel, etc., already present in the vegetable waste and add other characteristics by using fillers, plasticizers, or thickeners, such as by developing appropriate processes that partially conserve and partially modify the structure while maintaining the desired amounts of each component. The process of obtaining fibers from cotton, which are mostly made up of cellulose, is an example and involves separating cotton fiber from seeds, called ginning. The fiber then undergoes processes such as opening, blending, cleaning, carding, combing and so forth. Furthermore, it is treated in a draw frame and speed frame before the fibers are spun into yarns. More recently, several applications were developed that reconstruct and modify natural materials.

Aspects of the invention include a method of producing a leather-like material, the method comprising the steps: providing a waste from a plant-based material; drying the waste to form a dried waste material having a lower moisture content at a second state than at an original first state; grinding the dried waste material to a powder with granulometry of less the 100 micron; treating the powder with acidic water; centrifuging and washing the powder to produce a washed powder; preparing a dispersion of the washed powder in water; and distributing the dispersion on a surface and drying the dispersion at a temperature of between about 20° C. to about 110° C. for a drying duration to produce a dried material.

Leather and leather-like materials, as used herein, are understood to mean plant-based materials and leather derived from plant-based materials that include vegetables, fruits, and plants. The drying duration can be at least 24 hours.

The plant-based waste can be gathered or obtained from at least one of an apple, a citrus, a pomegranate, a banana, a pineapple, a mango, a kiwi, a tomato, a potato, a carrot pomace, cabbage leaves, parsley stems, rose buds, rose petals, tulip stems, tulip petals, bean husks, and cocoa husks.

The process can further comprise adding a plasticizer to the dispersion.

The process or method can further comprise adding a polymer binder to the dispersion.

The method can further comprise coating the dried material with a protective coat.

The method can further comprise coupling the dried material with a supporting material, which can be referred to as a frame or a skeleton.

A thickness of the dried material, such as the dried plant-based material, can be from about 0.05 mm to about 10 mm.

The dried material can be used in an outer garment or an accessory.

The method can further comprise adding inorganic salt to the acidic water.

The dispersion can be heated to about 40° C. to 100° C. to dry.

The plant-based waste can be from a single vegetable waste source, such as from kiwi wastes only.

The plant-based waste can be obtained from at least two vegetable sources, such as from kiwi wastes and from mango wastes.

The method can further comprise stitching different sections of the dried material to form a stitched whole section having a surface area that is larger than at least two of the stitched sections.

The stitched whole section can be used to form at least part of a chair, a seat, a belt, a shoe, a jacket, or a bag.

The dried material can be used to form at least part of a chair, a seat, a belt, a shoe, a jacket, or a bag.

A further aspects of the invention includes a leather-like material or patch. The leather-like material can be made from a plant-based waste comprising a composition of (1) cellulose of less than 50% wt/wt, (2) hemicellulose of less than 50% wt/wt, (3) pectin of less than 40% wt/wt, (4) lignin of less than 20% wt/wt, (5) aliphatic polyesters of less than 40% wt/wt, and (6) starch of less than 30% wt/wt.

A still further aspect of the invention comprises a method for producing a leather-like material. The method can comprise the steps: providing a waste from a single plant-based material or from a combination of several plant-based materials; drying the waste to form a dried waste material having a lower moisture content at a second state than at an original first state; grinding the dried waste material to a powder with granulometry of less the 100 microns; treating the powder with acidic water; centrifuging and washing the powder to produce a washed powder; preparing a dispersion of the washed powder in water; distributing the dispersion on a surface and drying the dispersion at a temperature of between about 20° C. to about 110° C. for a drying duration to produce a dried material; and applying a layer of a natural cross-linking agent over a surface of the dispersion.

The powder can have a granulometry of between 10 microns and 50 microns.

The acidic water can comprise an acetic acid, chloride acid, formic acid, or propionic acid in the range of 0.5 to 1.5 molarity.

The treating step can span at least 6 hours.

The dispersion can be distributed on an anti-adherent surface, a flat surface, or a textured surface.

The dried waste material can comprise at least five of the following six biopolymers: cellulose, hemicellulose, pectin, lignin, aliphatic polyesters, and starch.

The natural cross-linking agent can be at least one of genipin, proanthocyanidin, and epigallocatechin gallate.

The method can further comprise coupling the dried material to a supporting layer, and said supporting layer can comprise a textile fabric, a natural fiber, or a synthetic fiber.

The textile fabric can be one of a canvas, a denim, a jersey, or a linen. The natural fiber can be one of a banana, an Abacá, a wood pulp, a bamboo, a kapok, a coir, a cotton, a hemp, a jute, a kenaf, a lyocell, a modal, a piña, a raffia, a ramie, a rayon, a sisal, or a soy protein. The synthetic fiber can be one of a Kevlar, a nylon, a polyester, a microfiber, a carbon fiber, a glass fiber, or a basalt fiber.

The drying duration can be at least 24 hours.

The plant-based waste can be from at least one of an apple, a citrus, a pomegranate, a banana, a pineapple, a mango, a kiwi, a tomato, a potato, a carrot pomace, cabbage leaves, parsley stems, rose buds, rose petals, tulip stems, tulip petals, bean husks, and cocoa husks.

The method of claim 1, further comprising adding a plasticizer to the dispersion.

Plasticizers usable with the process can comprise of one or more of adipates, citrates, phosphate esters, phthalates, sebacates, trimellitate esters, polyglyceryne, epoxidized soybean oil (ESBO), epoxidized linseed oil (ELO), Glycerin Acetyl Tributyl Citrate, Polyethylene Glycols, Acetyl Triethyl Citrate, Polyethylene Glycol Monomethyl Ether, Castor Oil, Propylene Glycol Diacetylated Monoglycerides, Sorbitol Sorbitan Solution, Dibutyl Sebacate, Diethyl Phthalate, Triacetin, Tributyl Citrate, and Triethyl Citrate.

The plasticizer can comprise about 0.1% (w/w) to about 20% (w/w) of a final composition of the leather-like material.

The method can further comprise adding a polymer binder to the dispersion.

The thickness of the dried material can be from about 0.05 mm to about 10 mm.

The dried material can be used in an outer garment or an accessory.

The method can further comprise adding inorganic salt to the acidic water.

The dispersion can be heated to about 40° C. to 100° C. to dry.

The single plant-based material can be from one of a green kiwi, an apple, a citrus, a pomegranate, a banana, a pineapple, a mango, a tomato, a potato, a carrot pomace, a cabbage leaf, a parsley stem, a rose bud, a rose petal, a tulip stem, a tulip petal, a bean husk, or a cocoa husk.

The combination of several plant-based materials can comprise two or more of green kiwi, an apple, a citrus, a pomegranate, a banana, a pineapple, a mango, a tomato, a potato, a carrot pomace, a cabbage leaf, a parsley stem, a rose bud, a rose petal, a tulip stem, a tulip petal, a bean husk, and a cocoa husk.

The plant-based waste can be from at least two vegetable sources.

The method can further comprise stitching different sections of the dried material to form a stitched whole section and wherein the stitched whole section is used to form at least part of a bag, a chair, a seat, a belt, a shoe a jacket, or a bag.

The dried material made with the disclosed process can be used to form at least part of a bag, a chair, a seat, a belt, a shoe a jacket, or a bag.

Aspects of the invention further includes a leather-like material made from a plant-based waste comprising a composition of (1) cellulose of less than 50% wt/wt, (2) hemicellulose of less than 50% wt/wt, (3) pectin of less than 40% wt/wt, (4) lignin of less than 20% wt/wt, (5) aliphatic polyesters of less than 40% wt/wt, (6) starch of less than 30% wt/wt, and (7) a layer of a natural cross-linking agent.

The natural cross-linking agent can be at least one of genipin, proanthocyanidin, and epigallocatechin gallate.

The leather-like material can have a tensile modulus value of 88 MPa±7 MPa.

The leather-like material can have a tensile strength of 3.46 Mpa±0.35 MPa.

The leather-like material can have a length X and an elongation at X plus 14%±3% at break value.

In an example, the method or process can involve the treatment of the plant-based powder, such as the vegetable powder, in diluted acidic solution and water, in the range 1.5 M-0.5M molar or molarity using acetic acid or chloride acid or formic acid or propionic acid at temperature in the range of 20° C. to 40° C. for about 6 hours, more preferably for about 12 hours, more preferably for about 24 hours.

Inorganic salts can be added in order to jellify pectin macromolecules present in the plant-based material, such as vegetable that has been diluted in acidic solution, and create ties among the particles. Inorganic salts usable with the invention include CaCl₂), FeCl₃, MgCl₂, NaBO₃, CaCO₃.

Then, the hydrolyzed plant-based material can then be centrifuged to remove the acidic medium.

The material can then be resuspended in deionized water and stirred for about 1 hour, more preferably for about 2 hours. The resuspended plant-based material may more broadly be referred to as a slurry.

The slurry can then be heated in the range of about 40° C. to 100° C., preferably in the range of about 50° C. to 90° C., more preferably in the range of about 60° C. to 80° C.

Plasticizer and filler can be added and the slurry stirred for about 1 hour, preferably for about 2 hours, more preferably for about 4 hours. After that, the slurry can be transferred on the substrate and let dry for about 48 hours at room temperature.

In some embodiments the drying process can be conducted in the range of about 20° C. to 100° C., preferably in the range of about 40° C. to 90° C., more preferably in the range of about 50° C. to 80° C. The transfer may consist in the simple casting on an anti-adherent surface, flat or textured, whereupon the texture from the surface is impressed on the material and the material is later removed as a self-standing film. In an example, the transfer can consist of coating the substrate as described above via doctor blade or dip coating. Doctor blade coating is a technique used to form films with defined thicknesses. The technique works by placing a sharp blade at fixed distance from the surface that needs to be covered. The coating solution is then placed in front of the blade and the blade is moved across in-line with the surface, creating a wet film.

The disclosed process can be performed using a variety of different plant-based materials, of which non-limiting examples include: peels from apple, citrus, pomegranate, banana, pineapple, mango, kiwi, tomato, potato. Other non-limiting examples can include carrot pomace, cabbage leaves, parsley stems, rose buds, rose petals, tulip stems, tulip petals, bean husks, cocoa husks. By way of the noted examples, plant-based materials include vegetables, fruits, and plants.

Ideally, the selected plant-based material contains at least four, preferably at least five or six, biopolymers discussed above belonging to the big six. Where the selected single plant-based material does not fit the noted “big six” composition, such as having at least four of the big six biopolymers, it is possible to blend two or more plant-based material types to ensure that the desired composition is obtained. In some examples, as shown in Table I, the compositions can comprise fewer than all of the big six biopolymers.

In one embodiment, a plasticizer is used or added to the slurry. Non limiting examples for plasticizers are adipates, citrates, phosphate esters, phthalates, sebacates, trimellitate esters, polyglyceryne, epoxidized soybean oil (ESBO), and epoxidized linseed oil (ELO), Glycerin Acetyl Tributyl Citrate, Polyethylene Glycols, Acetyl Triethyl Citrate, Polyethylene Glycol Monomethyl Ether, Castor Oil, Propylene Glycol Diacetylated Monoglycerides, Sorbitol Sorbitan Solution, Dibutyl Sebacate, Diethyl Phthalate, Triacetin, Tributyl Citrate, and Triethyl Citrate.

The plasticizer may consist of about 0.1% (w/w) to about 20% (w/w) of the final composition of the leather-like material. Biocompatible plasticizers obtained from renewable stocks are preferred. Non-limiting examples of fillers include cotton, corn husks, graphite, clay, paper pulp, wood flour, metallic oxides like ZnO, and saw dust.

In another embodiment, a polymer binder can be used with the slurry. Non limiting examples for polymer binders are acrylic acid-based polymers, polyacrylamides, silicon, and alkylene oxide-based homopolymers and copolymers, polyethylene glycols (PEGs), aliphatic polyesters, such as poly (lactic acid) (PLA), poly (caprolactone) (PCL), and poly (3-hydroxybutyrate-co-3 hydroxy valerate), cellulose esters (cellulose acetate, cellulose acetate phthalate, cellulose acetate butyrate, cellulose acetate trimellitate, hydroxypropyl methylcellulose phthalate), polyvinylpyrrolidone, copolymers of vinylpyrrolidone and vinyl acetate (PVP/VA), anionic polymers (derived from carboxylic acid), such as copolymers of vinyl acetate and crotonic acid, copolymers of methyl vinyl ether and maleic esters and polyacrylic resins, amphoteric polymers, gum Arabic, and dimethylhydantoin-formaldehyde.

The polymer binder may consist of about 0.1% (w/w) to about 20% (w/w) of the final composition of the leather-like material. In some examples, two or more polymer types may be used up to the noted final composition.

In one embodiment, the leather-like material of the present invention, which can be understood as a plant-based leather made from a plant-based material, has a thickness in the range of about 0.05 mm to about 10 mm, preferably in the range from about 0.1 mm to about 5 mm, and more preferably in the range from about 0.2 mm to about 1 mm.

Preferably, the tensile strength of the leather-like material in accordance with aspects of the invention is sufficiently strong for performance and durability in various applications, including serving as materials for shoes, clothing, belts, backpacks, purses, and seat covers, among others.

In a preferred embodiment, the leather-like material formed using the disclosed process has a tensile strength in the range of from about 5 N/nm² to about 20 N/nm², preferably about 5 N/nm² to about 12N/nm², more preferably about 6 N/nm² to about 12 N/nm², more preferably about 8 N/nm² to about 10 N/nm². The tensile strength of the leather-like material is important when evaluating the flexibility, strength, and durability of the product.

A good tensile strength results in a leather-like material suitable for the production of shoes, boots, outfits, handbags, book bindings, sports equipment, furnishing, interior décor, toys, and automobile furnishing, as non-limiting examples.

In one embodiment, the leather-like material, from plant-based materials, can be subjected to different dyes to achieve a colored leather-like material. Optionally, the leather-like material can be subjected to bleaching for odor and color harmonization.

In one embodiment, the leather-like material can be coated with a protective transparent coating to regulate the aesthetics properties, such as gloss, or to provide further protection from water and humidity. In an example, a colloidal collagen of type I coating can be deposited in a micrometric layer on the surface of the plant-based leather. A collagen layer having a thickness in the range of about 0.001 mm to about 0.1 mm may be deposited on the leather-like material for protection, preferably in the range from about 0.001 mm to about 0.05 mm, and more preferably in the range from about 0.005 mm to about 0.02 mm.

The collagen can be crosslinked by adding genipin, a natural cross-linking agent. Genipin is known to be an efficient crosslinker and less toxic than others, such as glutaraldehyde. Genipin can be extracted from fruits, such as gardenia fruit. Other natural cross-linking agents are contemplated, including proanthocyanidin (PA) and epigallocatechin gallate (EGCG).

In one embodiment, the leather-like material based on plant-based material can be coated via sol-gel processes. A nanometric layer of silica can be deposited on the plant based leather thus modifying the surface to confer hydro and oil-repellency. The silica can act as a protective coating, improving the rubbing performance of the substrate. Silica layer having a thickness in the range of about 1 nm to about 200 nm, preferably in the range from about 5 nm to about 100 nm, and more preferably in the range from about 10 nm to about 20 nm, may be practiced.

In one embodiment, the hydrophobicity of the surface of the plant based leather is increased by treatment with plasma surface treatment for surface modification. In yet other examples, the surface of the plant-based leather may be treated by more than one of the disclosed processes. For example, the plant based leather can be coated with a protective layer and treated with plasma surface treatment.

The process may contain some, all, or only part of the listed optional steps. The final composition formed using the disclosed process may cover a desired surface area, or may be stitched together to secure the desired surface area.

### BRIEF DESCRIPTION OF THE DRAWINGS

These and other features and advantages of the present devices, systems, and methods will become appreciated as the same becomes better understood with reference to the specification, claims and appended drawings wherein:

FIG. 1 is a schematic flow diagram depicting a method or process for forming a plant-based leather material in accordance with aspects of the invention.

FIG. 2 is a schematic flow diagram depicting another method or process for forming a plant-based leather material in accordance with aspects of the invention.

FIG. 3 shows a C-13 CPMAS spectrum of green kiwi peel (GKP), which is a solid-state cross-polarization magic angle spinning carbon-13 nuclear magnetic resonance (CP/MAS 13C-NMR) used to investigate the composition of the kiwi material.

FIG. 4 is a graph showing the granulometry of GKP powder used in the disclosed process, as acquired with a laser diffraction particle size analyzer.

FIG. 5A shows a couple of examples of plant-based leather patches produced by the processes of the present invention.

FIG. 5B tensile properties of the samples of FIG. 5A depicted in a stress-strain curve tested according to ISO 527-3 method for films.

FIGS. 6A and 6B depict a shoe in the form of a high heel incorporating the plant-based material of the present invention.

FIG. 7 depicts another shoe in the form of a high heel incorporating the plant-based material of the present invention.

FIG. 8 is a belt having a strap made from a plant-based material of the present invention.

FIGS. 9 and 10 depict two different bucket sheets each with a back support and a set support and each incorporating the plant-based material of the present invention.

FIG. 11 depicts two helm chairs, typically found on boats or ships, each with a back support and a set support and each incorporating the plant-based material of the present invention.

FIG. 12 depicts a bag or a purse made from a plant-based material of the present invention.

### DETAILED DESCRIPTION

The detailed description set forth below in connection with the appended drawings is intended as a description of the presently preferred embodiments of plant-based leather, applications of said plant-based leather, and process of fabricating said plant-based leather in accordance with aspects of the present devices, systems, and methods and is not intended to represent the only forms in which the present devices, systems, and methods may be constructed or utilized. The description sets forth the features and the steps for constructing and using the embodiments of the present devices, systems, and methods in connection with the illustrated embodiments. It is to be understood, however, that the same or equivalent functions and structures may be accomplished by different embodiments that are also intended to be encompassed within the spirit and scope of the present disclosure. As denoted elsewhere herein, like element numbers are intended to indicate like or similar elements or features.

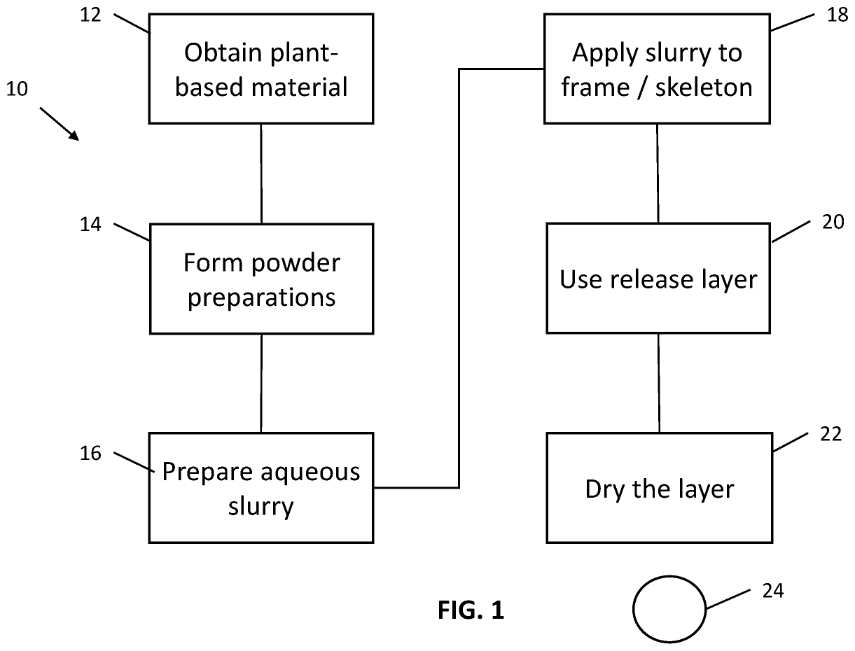

FIG. 1 depicts an exemplary process in accordance with aspects of the invention, which process is generally designated as 10. In an example, the process 10 comprises the steps of obtaining a plant-based material at 12, which can be a whole material but preferably a plant waste, such a kiwi peel. The process further includes the step of grinding a plant-based material at 14, preparing an aqueous slurry containing the plant-based material at 16, which can be a vegetable dispersion. The process then can further comprise applying the slurry to a textile substrate composed at 18. The textile substrate may be referred to as a frame or a skeleton and can comprise a yarn to form a yarn embedded layer. The process can further comprises covering the yarn embedded layer with a release paper at 20, which can be optional and can be omitted. The process can further include drying the layer at step 22. The process can include free OH and COOH groups undergoing a condensation reaction, also referred to as esterification. In other examples, a different material is used than textile. For example, a web of nonwoven fabric or netting may be used to cast the slurry. In still yet other examples, the slurry can be cast on a surface without the frame or skeleton. The resultant product 24 formed by the disclosed process can be a patch of plant-based leather-like material having mechanical properties of animal leather. Different mechanical properties are further discussed below. Further, the process 10 described can comprise essentially of the listed steps. In yet another embodiment, the process 10 can consist of the listed steps.

The basic process 10 described in FIG. 1 can be adjusted or modified for use with different plant-based materials or a combination of plant-based materials. Thus, aspects of the invention can further include providing a universal method for the fabrication of plant-based leather-like sheets, or plant-based leather for short. The method can exploit plant-based waste, such as vegetable waste, produced in transformation of food, either in the field or in production plants, focusing on the parts that are inherently nonedible. The obtained material from the disclosed process can have physical and aesthetical properties comparable to those of animal leather, has the same physical appeal, is water resistant, has appropriate tensile strength, and is abrasion resistant. Of course, whole plant-based materials, such as fresh whole mangos and kiwis, rather waste may be used in connection with the disclosed process.

The invention can also be embodied in coated articles having a substrate with a least one layer of fabric, which can be knitted or non-woven, with at least one layer of plant-based leather, such as vegetable-based leather, attached to the surface of the substrate. The substrate can alternatively be a web or pattern of strings, from natural or synthetic fibers. Exemplary strong strings include twine, Kevlar threads, and FireLine threads. Layers of plant-based leather, such as vegetable leather, can deposit on the substrate to form a reinforced leather-like material. Alternatively, the plant-based material can surround the frame or skeleton rather than just forming a layer on one side of the frame or skeleton.

The present invention can also be embodied in coated articles having a substrate with a least one layer of paperboard, paper, rubber, metal, or combinations thereof, with at least one layer of plant-based leather attached to the surface of the substrate.

According to another aspect of the inventive concept, a method is provided for producing a leather or leather-like material based on the following composition in terms of the big six constituents: (1) cellulose less than 50% wt/wt, preferably less than 40%, and preferably more than 25%; (2) hemicellulose less than 50%, preferably less than 40%, and preferably more than 25%; (3) pectin less than 40%, preferably less than 30%, and preferably more than 15%; (4) lignin less than 20%, preferably less than 10%, and preferably more than 5%; (5) aliphatic polyesters less than 40%, preferably less than 30%, and preferably more than 10%; and (6) starch less than 30%, preferably less than 20%, and preferably less than 10%. This composition can be obtained by a single plant-based waste, such as a vegetable waste, the skin, the pomace, seed, etc., or by mixing several residues or waste products together. Composition of the plant-based material can be determined by solid state C-13 nuclear magnetic resonance (NMR), which is the application of nuclear magnetic resonance spectroscopy to carbon.

Indeed, the disclosed process 10 may be appended, adjusted, or modified by one or more of the following steps or options. In an example, the method or process can involve milling a plant-based material, such as a vegetable like a mango or a kiwi, to produce a powder with controlled granulometry as determined for example by a Particle Size Analyzer. Dimensions of the powder particles can range between 1 micron and 1 mm, preferably between 5 microns and 100 microns, and more preferably between 10 microns and 50 microns.

In an example, the method or process can involve the treatment of the plant-based powder, such as the vegetable powder, in diluted acidic solution and water, in the range 1.5 M-0.5M molar or molarity using acetic acid or chloride acid or formic acid or propionic acid at temperature in the range of 20° C. to 40° C. for about 6 hours, more preferably for about 12 hours, more preferably for about 24 hours.

Inorganic salts can be added in order to jellify pectin macromolecules present in the plant-based material, such as vegetable that has been diluted in acidic solution, and create ties among the particles. Inorganic salts usable with the invention include CaCl₂), FeCl₃, MgCl₂, NaBO₃, CaCO₃.

Then, the hydrolyzed plant-based material can then be centrifuged to remove the acidic medium. The material can then be resuspended in deionized water and stirred for about 1 hour, more preferably for about 2 hours. The resuspended plant-based material may more broadly be referred to as a slurry.

The slurry can then be heated in the range of about 40° C. to 100° C., preferably in the range of about 50° C. to 90° C., more preferably in the range of about 60° C. to 80° C. Plasticizer and filler can be added and the slurry stirred for about 1 hour, preferably for about 2 hours, more preferably for about 4 hours. After that, the slurry can be transferred on the substrate and let dry for about 48 hours at room temperature. In some embodiments the drying process can be conducted in the range of about 20° C. to 100° C., preferably in the range of about 40° C. to 90° C., more preferably in the range of about 50° C. to 80° C. The transfer may consist in the simple casting on an anti-adherent surface, flat or textured, whereupon the texture from the surface is impressed on the material and the material is later removed as a self-standing film. In an example, the transfer can consist of coating the substrate as described above via doctor blade or dip coating. Doctor blade coating is a technique used to form films with defined thicknesses. The technique works by placing a sharp blade at fixed distance from the surface that needs to be covered. The coating solution is then placed in front of the blade and the blade is moved across in-line with the surface, creating a wet film.

The disclosed process can be performed using a variety of different plant-based materials, of which non-limiting examples include: peels from apple, citrus, pomegranate, banana, pineapple, mango, kiwi, tomato, potato. Other non-limiting examples can include carrot pomace, cabbage leaves, parsley stems, rose buds, rose petals, tulip stems, tulip petals, bean husks, cocoa husks. By way of the noted examples, plant-based materials include vegetables, fruits, and plants.

Ideally, the selected plant-based material contains at least four, preferably at least five or six, biopolymers discussed above belonging to the big six. Where the selected single plant-based material does not fit the noted “big six” composition, such as having at least four of the big six biopolymers, it is possible to blend two or more plant-based material types to ensure that the required composition is obtained. In some examples, as shown in Table I, the compositions can comprise fewer than all of the big six biopolymers.

In one embodiment, a plasticizer is used or added to the slurry. Non limiting examples for plasticizers are adipates, citrates, phosphate esters, phthalates, sebacates, trimellitate esters, polyglyceryne, epoxidized soybean oil (ESBO), and epoxidized linseed oil (ELO), Glycerin Acetyl Tributyl Citrate, Polyethylene Glycols, Acetyl Triethyl Citrate, Polyethylene Glycol Monomethyl Ether, Castor Oil, Propylene Glycol Diacetylated Monoglycerides, Sorbitol Sorbitan Solution, Dibutyl Sebacate, Diethyl Phthalate, Triacetin, Tributyl Citrate, and Triethyl Citrate. The plasticizer may consist of about 0.1% (w/w) to about 20% (w/w) of the final composition of the leather-like material. Biocompatible plasticizers obtained from renewable stocks are preferred. Non-limiting examples of fillers include cotton, corn husks, graphite, clay, paper pulp, wood flour, metallic oxides like ZnO, and saw dust.

In another embodiment, a polymer binder is used. Non limiting examples for polymer binders are acrylic acid-based polymers, polyacrylamides, silicon, and alkylene oxide-based homopolymers and copolymers, polyethylene glycols (PEGs), aliphatic polyesters, such as poly (lactic acid) (PLA), poly (caprolactone) (PCL), and poly(3-hydroxybutyrate-co-3 hydroxy valerate), cellulose esters (cellulose acetate, cellulose acetate phthalate, cellulose acetate butyrate, cellulose acetate trimellitate, hydroxypropyl methylcellulose phthalate), polyvinylpyrrolidone, copolymers of vinylpyrrolidone and vinyl acetate (PVP/VA), anionic polymers (derived from carboxylic acid), such as copolymers of vinyl acetate and crotonic acid, copolymers of methyl vinyl ether and maleic esters and polyacrylic resins, amphoteric polymers, gum Arabic, and dimethylhydantoin-formaldehyde. The polymer binder may consist of about 0.1% (w/w) to about 20% (w/w) of the final composition of the leather-like material. In some examples, two or more polymer types may be used up to the noted final composition.

In one embodiment, the leather-like material of the present invention, which can be understood as a plant-based leather made from a plant-based material, has a thickness in the range of about 0.05 mm to about 10 mm, preferably in the range from about 0.1 mm to about 5 mm, and more preferably in the range from about 0.2 mm to about 1 mm.

Preferably, the tensile strength of the leather-like material in accordance with aspects of the invention is sufficiently strong for performance and durability in various applications, including serving as materials for shoes, clothing, belts, backpacks, purses, and seat covers, among others.

Tensile strength is a measurement of the force required to pull something such as a rope, a wire, or a structural beam to the point where it breaks. The tensile strength of a material is the maximum amount of tensile stress that it can take before failure, for example breaking. The two more used definitions of tensile strength are: yield strength and ultimate strength. Yield strength is a measurement of the stress a material can withstand without permanent deformation. Yield strength is the stress which will cause a permanent deformation of 0.2% of the original dimension. Ultimate strength us the maximum stress a material can withstand while being stretched or pulled before breaking. In brittle materials, the ultimate tensile strength is close to the yield point, whereas in ductile materials the ultimate tensile strength can be much higher. In the present invention, tensile strength is given in Newtons per square millimeter (N/nm²) equivalent to Mpa. In the present invention, tensile strength is determined according to the current ISO 3376-2011 standard.

In a preferred embodiment, the leather-like material formed using the disclosed process has a tensile strength in the range of from about 5 N/nm² to about 20 N/nm², preferably about 5 N/nm² to about 12N/nm², more preferably about 6 N/nm² to about 12 N/nm², more preferably about 8 N/nm² to about 10 N/nm². The tensile strength of the leather-like material is important when evaluating the flexibility, strength, and durability of the product. A good tensile strength results in a leather-like material suitable for the production of shoes, boots, outfits, handbags, book bindings, sports equipment, furnishing, interior décor, toys, and automobile furnishing, as non-limiting examples.

In one embodiment, the leather-like material, from plant-based materials, can be subjected to different dyes to achieve a colored leather-like material. Optionally, the leather-like material can be subjected to bleaching for odor and color harmonization.

In one embodiment, the leather-like material can be coated with a protective transparent coating to regulate the aesthetics properties, such as gloss, or to provide further protection from water and humidity. In an example, a colloidal collagen of type I coating can be deposited in a micrometric layer on the surface of the plant-based leather. A collagen layer having a thickness in the range of about 0.001 mm to about 0.1 mm may be deposited on the leather-like material for protection, preferably in the range from about 0.001 mm to about 0.05 mm, and more preferably in the range from about 0.005 mm to about 0.02 mm.

The collagen can be crosslinked by adding genipin, a natural cross-linking agent. Genipin is known to be an efficient crosslinker and less toxic than others, such as glutaraldehyde. Genipin can be extracted from fruits, such as gardenia fruit. Other natural cross-linking agents are contemplated, including proanthocyanidin (PA) and epigallocatechin gallate (EGCG).

In one embodiment, the leather-like material based on plant-based material can be coated via sol-gel processes. A nanometric layer of silica can be deposited on the plant based leather thus modifying the surface to confer hydro and oil-repellency. The silica can act as a protective coating, improving the rubbing performance of the substrate. Silica layer having a thickness in the range of about 1 nm to about 200 nm, preferably in the range from about 5 nm to about 100 nm, and more preferably in the range from about 10 nm to about 20 nm, may be practiced.

In one embodiment, the hydrophobicity of the surface of the plant based leather is increased by treatment with plasma surface treatment for surface modification. In yet other examples, the surface of the plant-based leather may be treated by more than one of the disclosed processes. For example, the plant based leather can be coated with a protective layer and treated with plasma surface treatment.

In one embodiment, the leather-like material is coupled with a supporting material, which may be referred to as a skeleton or frame, to modify the handling and performance of the leather-like material. The supporting material may be selected from a list of textile fabrics, such as canvas, denim, jersey, linen, etc., from natural fibers, such as banana, Abacá, Wood Pulp, Bamboo, Kapok, coir, cotton, Hemp, Jute, Kenaf, Lyocell, Modal, Piña, Raffia, Ramie, Rayon, Sisal, and Soy protein, or from synthetic fibers, such as Kevlar, nylon, polyester, microfiber, carbon fiber, glass fiber, and basalt fiber. The supporting material can also be a metal mesh or latex sheeting, among others.

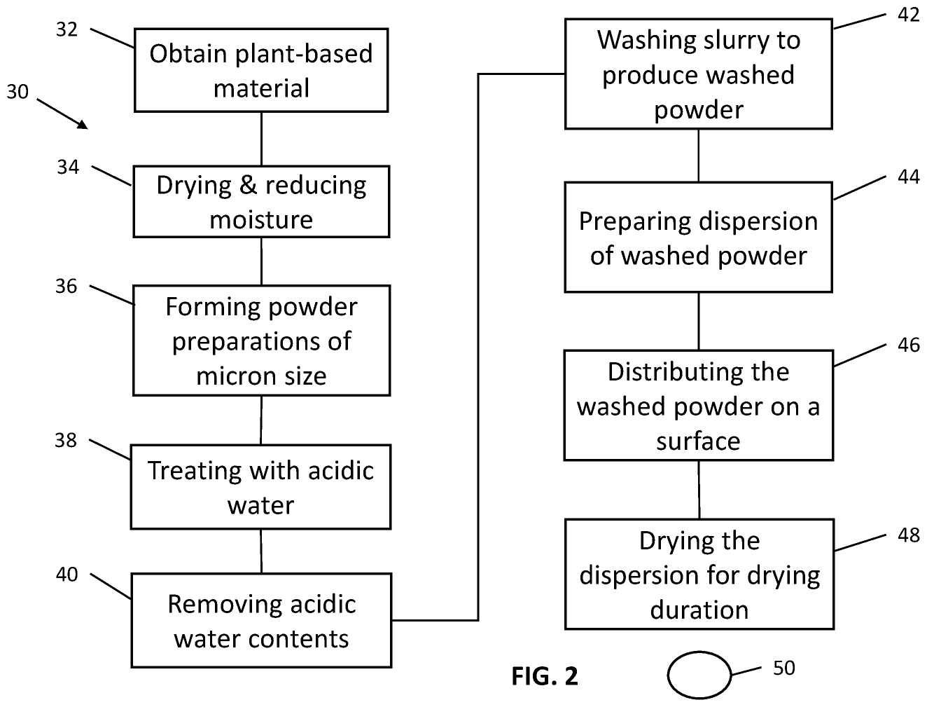

With reference now to FIG. 2, a method or process 30 of producing a leather-like material in accordance with aspects of the invention is shown. In an example, the process can comprise the steps of providing or obtaining a waste from a plant-based material at step 32. The process further comprises drying the waste to form a dried waste material having a lower moisture content at a second state than at an original first state at step 34. After drying, the process continues with grinding the dried waste material to a powder with granulometry of less than about 100 microns at step 36. The process can further comprise treating the powder with acidic water at 38 and then removing or extracting the acidic water at step 40, such as by centrifuging. The process can continue with washing the powder at step 42 to produce a washed powder and then preparing a dispersion of the washed powder in water at step 44. The washed powder is then distributed such as by spreading the dispersion on a surface at step 46. The process can then continue with drying the dispersion at a temperature of between about 20° C. to about 110° C. for a drying duration of about 47 h to produce a dried material at step 48. The washed powder may be called a slurry. The cast slurry may be formed on a substrate, such as a textile substrate, a nonwoven substrate, or a web. The cast slurry may also be treated with one or more additives, bleaching, crosslinkers, colorants or dyes, binders, protective coatings, etc., as described above elsewhere herein. The resultant product 50 formed by the disclosed process 30 can be a patch of plant-based leather-like material having mechanical properties of animal leather. Further, the process 30 described can comprise essentially of the listed steps. In yet another embodiment, the process 10 can consist of the listed steps.

### Example 1

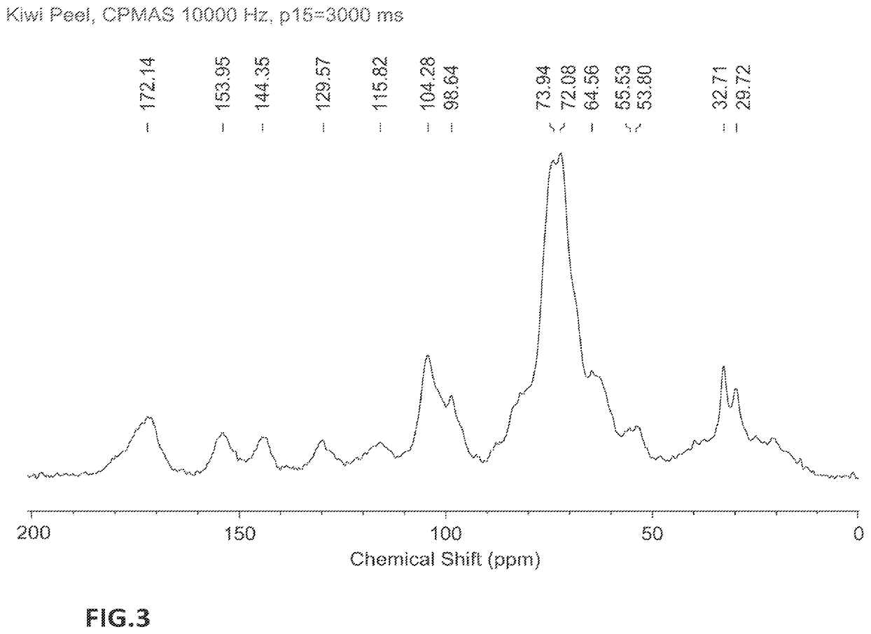

In an embodiment, green kiwi peel (GKP) is used as a starting plant-based material for the leather-like material. GKP can be obtained from kiwis purchased from food stores, picked from a tree, or recovered as wastes. In general, kiwis are rich in vitamins and contain antioxidants and beneficial fibers, mainly in the peel. Despite its beneficial properties, the kiwi peel is typically removed and discarded. In FIG. 3 or FIG. 3, the C-13 CPMAS spectrum of GKP is shown, which is a solid-state cross-polarization magic angle spinning carbon-13 nuclear magnetic resonance (CP/MAS 13C-NMR) used to investigate the composition of the kiwi material, in terms of the “big six” biopolymers.

The cellulose signals are the most intense peaks of the graph. As shown, the chemical shift regions 102-107 ppm, 80-92 ppm and 60-67 ppm are attributable to the C1, C4, and C6 signals respectively of the glucose unit of the cellulose. The C4 signal in the carbon spectrum of microcrystalline cellulose is the most reliable resonance used to determine the degree of crystallinity. In fact, C4 cellulose amorphous carbons give rise to a fairly broad signal ranging from 80-85 ppm, while C4 cellulose crystalline carbons generate a sharper resonance in the range 85-92 ppm. Close to the C1 signal of cellulose, at 101.8 ppm, the C1 signal of hemicellulose is present. The other signals of hemicellulose are in part overlapped with cellulose signals and can be found as shoulders at lower chemical shift with respect to C6 signal of cellulose. At around 30 ppm resonate, the carbon atoms of —CH₂ groups belonging to aliphatic chains of polyesters can be observed, but at the same time there is a broad component, caused by disorder at the microscopic level, attributable to substituents of polysaccharides, mainly methyl groups. At around 53 ppm, there are —OCH₃ groups from the pectin. At around 172 ppm resonate, the carboxylic groups of pectin together with those of the aliphatic polyesters can be observed. Finally, the region between 125 and 160 ppm is specific of aromatic carbons and carbons on double bonds. Lignin is characterized by a quite complex tridimensional structure, but it is well accepted that the main building block are syringil (S) and guaiacyl (G) units. The signal at 154 ppm is assigned to C-3 and C-5 of S units that are etherified at C-4. The signal at 144 ppm is also assigned to C-3 and C-5 of S units, but for those with free phenolic groups at C-4. Additionally, the signal at 144 ppm is assigned to C-3 and C-4 of G units. The signal at 130 ppm is assigned to C-1 and C-4 of S and G units that are etherified at C-4. The protonated carbons of syringyl (C-2 and C-6) units and guaiacyl units (C-2, C-5 and C-6) resonate around 116 ppm.

In a well acquired NMR spectrum, the signal intensity is typically proportional to the amount of each functional group, and the intensity of each peak can be enucleated by spectral deconvolution using an appropriate software.

In Table 1, the composition of GKP as determined from C-13 CPMAS spectrum is reported. In a specific example, starch is absent. As discussed above, a second or additional plant-based materials having the desired starch contents may be blended or mixed with the GKP composition to yield a composition with all “big six” biopolymers.

TABLE 1

| Composition | %(w/w) |
|---|---|
| Cellulose | 31.8 |
| Hemicellulose | 35.8 |
| Pectin | 19.7 |
| Lignin | 4.6 |
| Aliphatic Polyesters | 7.5 |

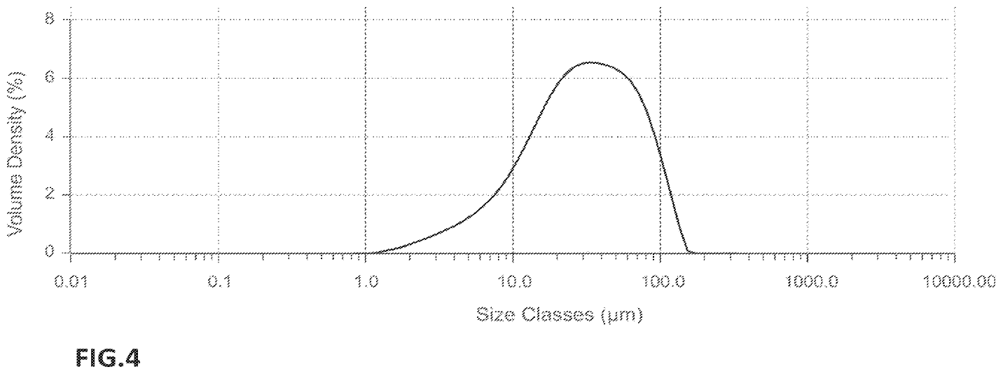

After acquiring GKP peels, the treatment starts with washing with tap water and deionized water to remove any traces of dirt or other contamination. Then the peels are dried at 60° C. for about 48 h. Afterwards the peels are ground with a ball miller for about 3 to 10 minutes, using steel bearings. The temperature should be monitored to avoid thermal degradation. Finally, the powder is separated with a 100 μm sieve. In FIG. 4 or FIG. 4, the granulometry of GKP, as acquired with a laser diffraction particle size analyzer, is depicted.

In the following, two possible treatments can be used, which are:

In a first exemplary treatment process, the powder, about 2 g, is treated in an aqueous solution of HCl (1.5M) of CaCl₂) for about 24 hours. After centrifuging and washing the obtained material to remove the acidic medium, it is redispersed in water. The dispersion is stirred for approximately another 24 h, after which it was cast in Teflon or glass pans and left to dry at about 50° C. for about 48 h. The resultant product is a plant-based leather-like material usable in a number of applications, as discussed elsewhere herein.

In a second exemplary treatment process, the plant-based powder, such as vegetable powder or fruit powder, about 2 g, was suspended in an aqueous solution of acetic acid (1M) at about 30° C. for about 24 h. CaCl₂) may optionally be added. Then, the hydrolyzed plant-based material was centrifuged to remove the acidic medium. The material was then resuspended in deionized water and stirred for about 1 h at about 80° C. to promote the gelatinization of the percentage of starch present in the waste. After that, the solutions were transferred to Teflon or glass pans and the water solvent was allowed to evaporate for about 48 h at room temperature. The resultant product is a plant-based leather-like material usable in a number of applications, as discussed elsewhere herein.

### Example 2

In another embodiment, a plasticizer is added to the plant-based dispersion in water at about 80° C., 20% (w/w) polyglycerin-4. The dispersion is then stirred for approximately another 24 h, after which it was cast in Teflon or glass pans and left to dry at about 50° C. for about 48 h. The resultant product is a plant-based leather-like material usable in a number of applications, as discussed elsewhere herein.

### Example 3

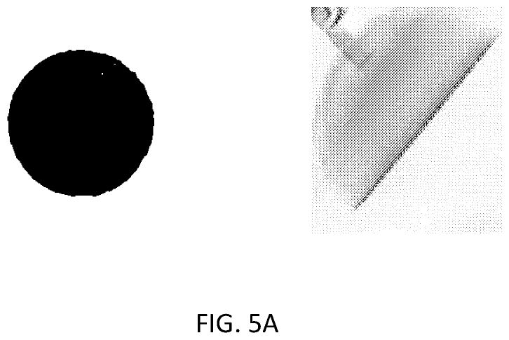

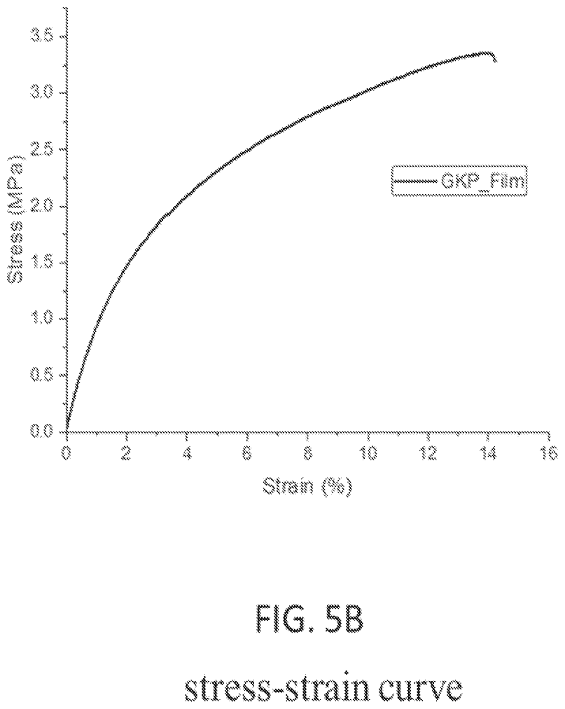

In other embodiment, a polymer binder is added to the plant-based dispersion, such as vegetable-based dispersion, in water at about 80° C., 20% (w/w) polyvinylpyrrolidone. The dispersion is then stirred for about 24 h, after which it was cast in Teflon or glass pans and left to dry at about 50° C. for about 48 h. Two samples of leather-like materials are shown in FIG. 5A, which are usable in a number of applications, as discussed elsewhere herein. The particular leather-like materials shown are constituted by 60% GKP, 20% Polyglyceryne-4, and 20% polyvinylpyrrolidone.

The tensile properties depicted in the stress-strain curve of FIG. 5B for the samples shown in FIG. 5A were tested according to ISO 527-3 method for films. From cast samples using slurries in accordance with aspects of the invention, ribbons or films of about 10 mm width and 0.35 mm thickness were obtained. The cast samples did not include an internal frame or substrate in order to test mechanical characteristics of the plant-based leather material derived from a slurry formed in accordance with aspects of the invention. A tensile testing machine (Universal Testing Machine, Zwick Roell, Germany) with a 100 N load cell and a gauge length of 35 mm was used. The test speed was adjusted to 1 mm/min, whereas the preload was 0.1 N. The tensile strength (MPa) and elongation at break were obtained from the software (TestXpert) and Young's modulus (MPa) was obtained by regression of stress-strain curve on the linear part between 0.1 to 0.5 strain (%), with five measurements for each sample. The stress-strain curve of FIG. 5B resembles a typical curve for natural or real leathers.

The resulting tensile modulus value (88±7 MPa), tensile strength (3.46±0.35 MPa), and elongation at break value (14%±3%) place the samples derived from the process and compositions, including slurries, in accordance with aspects of the invention falling within natural leather material. The process for making plant-based leather materials of the invention and plant-based materials having mechanical characteristics comparable to natural or real leathers can be used for a number of commercial applications, as further discussed below.

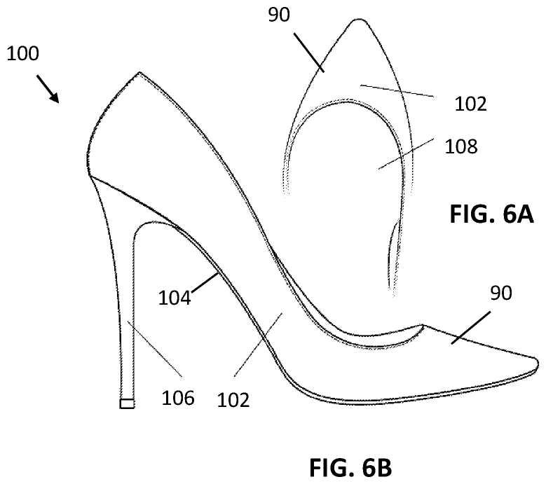

With reference now to FIGS. 6A and 6B, a shoe 100 in the form of a high heel and the upper portion 102 of the high heel 100 in accordance with aspects of the invention is shown, respectively. The upper portion 102 is attached to shank 104, which has a heel 106 attached to an end thereof of varying length and contour. Internally 108, the high heel is provided with lining and an insole lining. In an example, the high heel is formed at least in part with the leather-like material 90 formed by the disclosed process. For example, all of the upper portion 102, or certain sections or panels forming part of the upper portion 102 may be formed from the leather-like material 90, such as by stitching two or more panels when forming the upper portion.

In an example, the heel 106 is wrapped with the leather-like material 90 and glued to a solid core made from a hard plastic, wood, or composite. The insole lining may also be made from the disclosed leather-like material. Depending on the design and location of use, different thicknesses, colors, and textures may be selected.

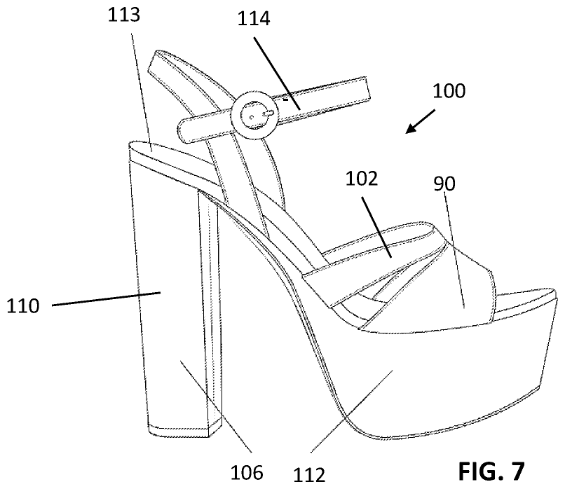

FIG. 7 depicts another shoe 100 in the form of a high heel having a sole 110 with a platform 112, an insole 113, and a heel 106. The high heel has an open upper portion 102 formed with different leather-like material sections 90 of different shapes and sizes and a strap 114 having buckle for adjusting the strap. The upper portion 102 and the strap 114 may be made from the disclosed leather-like material 90. In exemplary embodiments, the heel 106 and the platform 112 may also be lined with leather-like material, which can have a different thickness and texture than the material used for the upper portion and the strap.

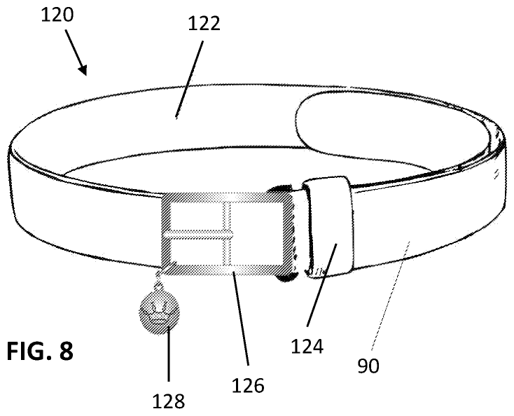

FIG. 8 shows a belt 120 in accordance with aspects of the invention. The belt 120 has a strap 122, a belt loop 124, and a buckle 126. An optional insignia or pendant 128 may be included, which can function as a trademark or an ornamental design. The strap and the belt loop can be made from the leather-like material 90 of the present invention.

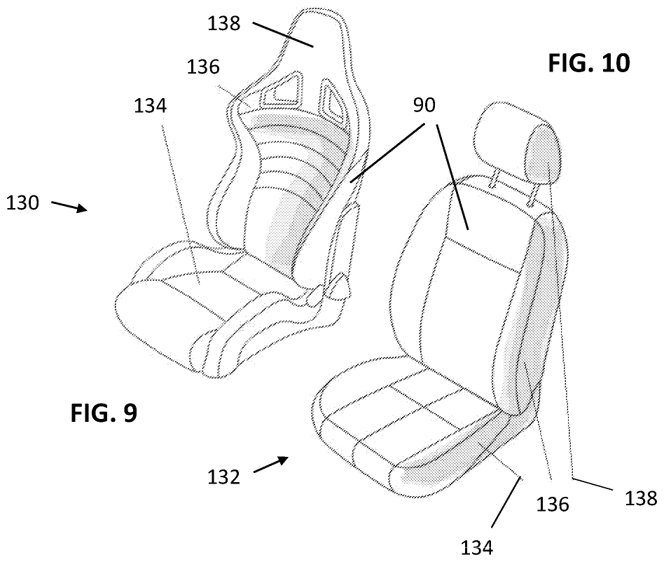

FIGS. 9 and 10 depict bucket seats 130, 132 in accordance with aspects of the invention. Each of the two bucket seats has a cushion assembly 134 and a back assembly 136. Whereas the bucket seat 130 of FIG. 9 has an integrated head rest 138, the bucket seat 132 of FIG. 10 has an adjustable head rest 138 with attachment links. The two bucket seats 130, 132 may be constructed with the leather-like material 90 of the preset invention. For example, sections of the cushion assembly and back assembly can be stitched together from sections of the leather-like material 90 of the present invention and then stretched and wrapped around padded frames of the bucket seats. The upholstered seats can have engraving, different stitching patterns, and sections of the same or different colors.

While the two bucket seats can be used for various vehicles, the bucket seat 130 of FIG. 9 can be adapted for high-end sports cars, such as Corvettes, Porsches, and Ferraris, to name a few non-limiting examples, and the bucket seat 132 of FIG. 10 can be adapted for family cars and vans, transportation vehicles, sedans, sport utilities, and other non-high-end sports cars.

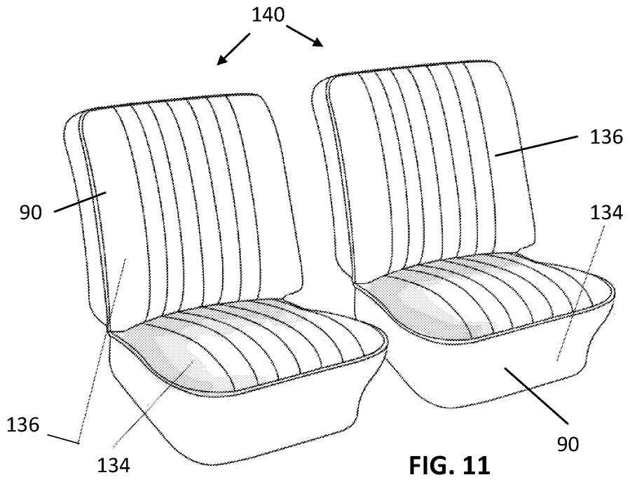

With reference now to FIG. 11, two helm chairs 140 are shown side-by-side. Each helm chair can comprise a cushion assembly 134 and a back assembly 136. Each helm chair 140 can be mounted to a frame by itself or adjacent to one or more other helm chairs. The helm chairs 140 are commonly found on yachts or boats and can be mounted to a stationary support frame or to a support column to enable rotation and height adjustments. The two helm chairs 140 may be constructed with the leather-like material 90 of the present invention. For example, sections of the cushion assembly 134 and back assembly 136 can be stitched together from sections of the leather-like material 90 of the present invention and then stretched and wrapped around padded frames of the bucket seats. The upholstered seats can have engraving, different stitching patterns, and sections of the same or different colors. The leather-like material 90 may be coated with a conditioner or lotion for improved wear and moisture resistant. Separately provided cushions, such as padded cushions, may be placed atop the exterior of the cushion assembly 134 to provide added comfort. The separately provided cushions may be made with the leather-like material disclosed herein.

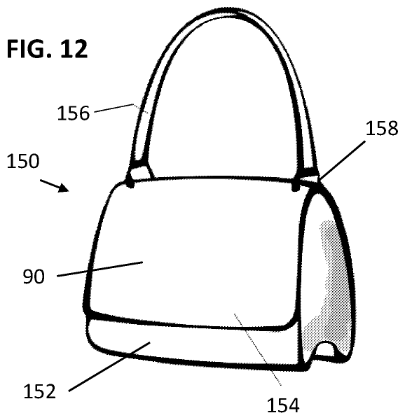

FIG. 12 shows a bag or purse 150 in accordance with aspects of the invention. The bag 150 comprises a body 152 having an optional flap 154. The bag 150 further comprises a handle 156 attached to the body via coupling rings 158. In some exemplary embodiments, the bag 150 may include one or more of a touret, a plague, a lock, a clochette, a zipper, and a side pocket, among others. The leather-like material 90 of the present invention may be used to construct the body, the flap, and the handle of the bag 150. To assist with forming various contours and curves, the leather-like material 90 may be fabricated on substrates having the desired contours and curves.

Methods of making and of using the leather-like material are within the scope of the present invention.

Although limited embodiments of methods for forming leather-like materials from vegetables and applications of the leather-like materials have been specifically described and illustrated herein, many modifications and variations will be apparent to those skilled in the art. Accordingly, it is to be understood that the methods for forming and the use of articles formed by the methods according to principles of the disclosed devices, systems, and methods may be embodied other than as specifically described herein. The disclosure is also defined in the following claims.

1.-24. (canceled)

25. A method of producing a leather-like material, the method comprising the steps:
providing a waste from a single plant-based material or from a combination of plant-based materials;
drying the waste to form a dried waste material having a lower moisture content at a second state than at an original first state;
grinding the dried waste material to a powder with granulometry of less the 100 microns;
treating the powder with acidic water;
centrifuging and washing the powder to produce a washed powder;
preparing a dispersion of the washed powder in water containing inorganic salts of bivalent or trivalent cations;
adding a plasticizer and a binder to the dispersion; and
distributing the dispersion on a surface and drying the dispersion at a temperature of between about 20° C. to about 110° C. to produce a dried material.

26. The method of claim 25, further comprising the step of applying a layer of a natural cross-linking agent over a surface of the dispersion.

27. The method of claim 25, wherein the powder has a granulometry of between 10 microns and 50 microns.

28. The method of claim 25, wherein the acidic water comprises an acetic acid, chloride acid, formic acid, or propionic acid in the range of 0.5 to 1.5 molarity and the treating step is at least 6 hours.

29. The method of claim 25, wherein the dried waste material comprises at least five biopolymers selected from the group consisting of cellulose, hemicellulose, pectin, lignin, aliphatic polyesters, and starch.

30. The method of claim 25, wherein the natural cross-linking agent is at least one of genipin, proanthocyanidin, and epigallocatechin gallate.

31. The method of claim 25, further comprising coupling the dried material to a supporting layer, said supporting layer comprising a textile fabric, a natural fiber, or a synthetic fiber.

32. The method of claim 31, wherein the textile fabric is one of a canvas, a denim, a jersey, or a linen, the natural fiber is one of a banana, an Abacá, a wood pulp, a bamboo, a kapok, a coir, a cotton, a hemp, a jute, a kenaf, a lyocell, a modal, a piña, a raffia, a ramie, a rayon, a sisal, or a soy protein, and the synthetic fiber is one of a Kevlar, a nylon, a polyester, a microfiber, a carbon fiber, a glass fiber, or a basalt fiber.

33. The method of claim 25, wherein the plant-based waste is from at least one of an apple, a citrus, a pomegranate, a banana, a pineapple, a mango, a kiwi, a tomato, a potato, a carrot pomace, cabbage leaves, parsley stems, rose buds, rose petals, tulip stems, tulip petals, bean husks, and cocoa husks.

34. The method of claim 25, further comprising adding a plasticizer to the dispersion.

35. The method of claim 34, wherein the plasticizer comprises one or more of adipates, citrates, phosphate esters, phthalates, sebacates, trimellitate esters, polyglyceryne, epoxidized soybean oil (ESBO), epoxidized linseed oil (ELO), Glycerin Acetyl Tributyl Citrate, Polyethylene Glycols, Acetyl Triethyl Citrate, Polyethylene Glycol Monomethyl Ether, Castor Oil, Propylene Glycol Diacetylated Monoglycerides, Sorbitol Sorbitan Solution, Dibutyl Sebacate, Diethyl Phthalate, Triacetin, Tributyl Citrate, and Triethyl Citrate.

36. The method of claim 25, wherein a thickness of the dried material is from about 0.05 mm to about 10 mm.

37. The method of claim 25, wherein the single plant-based material is from one of a green kiwi, an apple, a citrus, a pomegranate, a banana, a pineapple, a mango, a tomato, a potato, a carrot pomace, a cabbage leaf, a parsley stem, a rose bud, a rose petal, a tulip stem, a tulip petal, a bean husk, or a cocoa husk.

38. The method of claim 25, wherein the combination of plant-based materials comprises two or more of green kiwi, an apple, a citrus, a pomegranate, a banana, a pineapple, a mango, a tomato, a potato, a carrot pomace, a cabbage leaf, a parsley stem, a rose bud, a rose petal, a tulip stem, a tulip petal, a bean husk, and a cocoa husk.

39. The method of claim 25, wherein the plant-based waste is from at least two vegetable sources.

40. The method of claim 25, further comprising stitching different sections of the dried material to form a stitched whole section and wherein the stitched whole section is used to form at least part of a chair, a seat, a belt, a shoe a jacket, or a bag.

41. A plant-based leather material made from a plant-based waste containing:
a) cellulose of less than 50% wt/wt;
b) hemicellulose of less than 50% wt/wt;
c) pectin of less than 40% wt/wt;
d) lignin of less than 20% wt/wt;
e) aliphatic polyesters of less than 40% wt/wt;
f) starch of less than 30% wt/wt;
g) a layer of a natural cross-linking agent; and
h) an effective amount inorganic salts, plasticizers and binders.

42. The plant-based leather material of claim 41, wherein the natural cross-linking agent is at least one of genipin, proanthocyanidin, and epigallocatechin gallate.

43. The plant-based leather material of claim 41, wherein the plant-based leather material has a tensile modulus value of 88 MPa±7 MPa.

44. The plant-based leather material of claim 41, wherein the plant-based leather material has a tensile strength of 3.46 Mpa±0.35 MPa.

45. The plant-based leather material of claim 41, wherein the plant-based leather material has length X and an elongation at X plus 14%±3% at break value.
